(19) United States
(12) Patent Application Publication
(10) Pub. No.: US 2004/0089990 A1
(43) Pub. Date: May 13, 2004

(54) Single point attachment dual path suspension mount

(76) Inventor: George A. Labeau, Beavercreek, OH (US)

Correspondence Address: Michael D. Smith, Esq., DELPHI TECHNOLOGIES, INC., Legal Staff, Mail Code: 480-410-202, P. O. Box 5052, Troy, MI, 48007-5052, US

(21) Appl. No.: 10/701,726

(22) Filed: Nov. 5, 2003

Related U.S. Application Data
(63) Continuation-in-part of application No. 10/164,489, filed on Jun. 6, 2002, now abandoned.

(51) Int. Cl. B60G 15/00; F16M 9/00

(52) U.S. Cl. 267/220; 267/140.13

(57) ABSTRACT

A mount assembly for connecting a damper rod to a body includes a tower including an annular opening and a proximal attachment portion. The tower is connected to the body at the proximal attachment portion. The mount assembly further includes a mount housing having a vertical portion extending through the annular opening and a flange disposed on one side of the tower. A nut is disposed on a side of the tower opposite the one side and engaged with the vertical portion of the mount housing. The mount assembly further includes a resilient cushion assembly disposed within the vertical portion of the mount housing so that the damper rod extends through the resilient cushion assembly, and a spring engaged with the tower and adapted to transfer loads to the tower.

### PRIORITY

This application claims priority to U.S. patent application Ser. No. 10/164,489 filed Jun. 6, 2002 as a continuation in part, and hereby incorporates by reference that entire application.

### TECHNICAL FIELD OF THE INVENTION

This invention relates generally to a damper mount assembly, and relates more particularly to a single point attachment mount assembly for suspension dampers.

### BACKGROUND OF THE INVENTION

The typical suspension includes a damper in the form of a strut or a shock that is mounted between the sprung (body), and unsprung (assembly) masses of the body to dampen spring oscillations. The lower end of the damper is connected to the assembly in a suitable manner, and the upper end is connected to the body structure, usually at a tower, by an upper damper mount assembly. With conventional upper mounts, a coil spring supports the weight of the body and creates a force that is proportional to the relative velocity between the assembly and the body, transferring loads to the mount. In addition, ajounce bumper acts as a stop for compression directed movement of the damper transferring loads to the mount. Since the damper is connected to the body by the upper mount, the upper mount must support the total weight of the body and provide acceptable isolation. Achieving these properties requires proper tuning of the mount. Tuning is complicated by the fact that relatively high spring and jounce bumper loads have to be accommodated through the mount.

Conventional upper mounts include at least one resilient element, normally a rubber cushion, to isolate and reduce the transmission of input forces to the body. An upper mount is generally required to be firm enough to support the weight of the body while simultaneously resilient enough for isolation purposes. For certain inputs, deflection of the upper mount is desirable while for other inputs it is preferable for the upper mount to resist deflection. Single path upper mounts are known, wherein the actuator or damper rod and a coil spring seat are fastened together and the load path is through a single rubber cushion. The single rubber cushion accommodates the forces generated by both the actuator or damper and the cooperating coil spring. The rubber cushion is preloaded by the body weight. Dual path mounts are also known, wherein the actuator or damper rod and the coil spring seat are not fastened together and wherein the load path is through separate rubber cushion assemblies. A first rubber cushion assembly engages the coil spring and supports the body weight, and a second rubber cushion assembly engages the actuator or damper rod and is not preloaded by body weight.

The conventional upper mount assembly is attached to the tower by a plurality of fasteners that are distributed around the mount near its outer perimeter. It is also known to secure the mount to the tower by placing components of the mount on opposite sides of the tower and capturing them by a nut threaded to a piston rod tenon of the damper. U.S. Pat. No. 6,161,822, the disclosure of which is hereby incorporated by reference, shows a similar single point attachment mount featuring several engagement openings.

### SUMMARY OF THE INVENTION

The present invention is a mount assembly for connecting a damper rod to a motor tower. The mount assembly comprises a mount housing, a nut, and a resilient cushion. The mount housing has a vertical portion extending through an opening in the tower, and a flange disposed on one side of the tower. The nut is disposed on a side of the tower opposite the one side, and is engaged with the vertical portion of the mount housing. The resilient cushion is disposed within the vertical portion of the mount housing, the damper rod extending through the resilient cushion assembly. A spring engaged with the tower is adapted to transfer loads from the body to the tower.

Accordingly, it is an object of the present invention to provide a mount assembly of the type described above that attaches to the tower at a single point.

Another object of the present invention is to provide a mount assembly of the type described above that accepts damper loads in shear.

Still another object of the present invention is to provide a mount assembly of the type described above that reduces product and assembly costs by the elimination of redundant fasteners as well as improved cycle time due to the reduction of repeated fastening actions on the assembly line.

Still another object of the present invention is to provide a mount assembly of the type described above that provides separate paths for body loads and damper loads.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross-sectional view of a suspension mount assembly according to the present invention attached to a damper and a tower;

FIG. 2 is an exploded view of the suspension mount assembly; and

FIG. 3 is a cross-sectional view of a suspension mount assembly according to the present invention attached to a damper and a tower.

### DETAILED DESCRIPTION OF THE PRESENTLY PREFERRED EMBODIMENTS

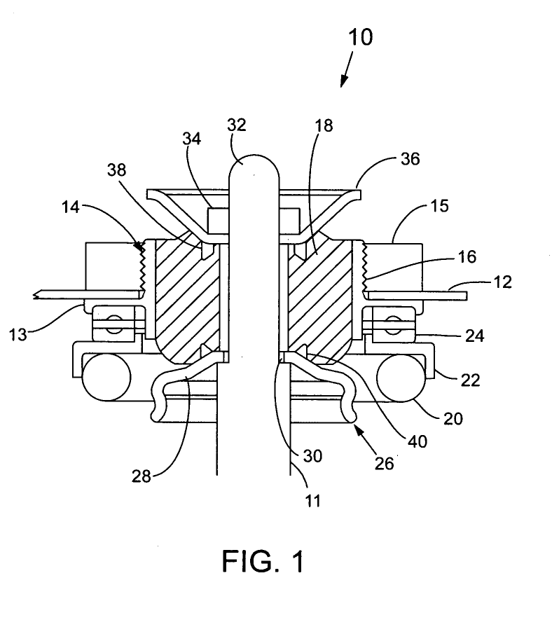

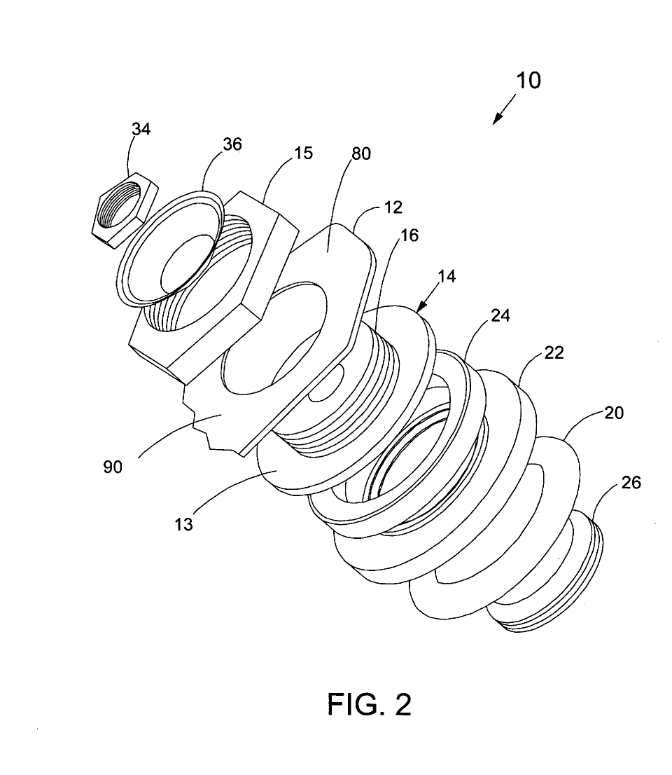

FIGS. 1 and 2 show one embodiment 10 of an upper suspension mount assembly for connecting a damper rod 11 to a body tower 12. In general, the mount assembly 10 is rigidly attached to the tower 12 at a single point, by trapping the tower between a flange 13 on mount housing 14 and a nut 15 engaged with external threads on a vertical portion 16 of the mount housing. In operation, the damper rod 11 is free to move relative to the tower 12, but no relative movement is intended between the mount housing 14 and the tower. This preferred illustrated embodiment provides for two separate load paths through the mount assembly 10. The loads created by the damper, and transmitted from the damper rod 11, pass through a resilient cushion assembly 18 to the tower 12. Other loads transmitted to the mount assembly 10, such as those that might be transmitted by the body through a spring 20, pass through a spring seat 22 and a bearing 24 to the mount housing 14 and the tower 12.

The tower 12 is, in one embodiment, an inverted cup-shaped element with an annular sidewall, and is formed as part of a body stamping in a well-known manner. In a preferred embodiment, the tower 12 is round or circularly shaped, and the mount assembly 10 is correspondingly shaped for mating reception therein so that no specific initial angular orientation of the mount assembly relative to the tower is required for assembly. The mount assembly 10 can of course adopt alternate shapes, such as oval or oblong, that may present some advantages in specific applications such as allowing the mount to have performance differentials (tunability) in the different motion directions of the body suspension. As shown in FIG. 2, tower 12 comprises a proximal portion 90 and a distal side 80. Proximal portion 90 is a portion of the tower 12 that provides the support for the mount assembly 10, and distal side 80 is a terminal edge of the tower 12. Tower 12 surrounds the tenon 32. Specifically, the connection between the tower 12 and the body consists of proximal portion 90 of tower 12.

A lower rate washer 26 is, in one embodiment, formed of an acceptably rigid material such as metal, and includes a shoulder 28 around an opening 30. The damper piston rod 11 abuts the shoulder 28, and a tenon 32 of the rod extends through the opening 30. A nut 34 is threadingly engaged with the upper portion of the tenon 32 to compress and capture the cushion assembly 18 between an upper rate washer 36 and the lower rate washer 26 and within the mount housing 14. The cushion assembly 18 may optionally or additionally be bonded by well known processes to the support surfaces of those components.

The cushion assembly 18 is, in one embodiment, formed of an elastomer that provides a selected level of damping between the damper rod 11 and the tower 12. To facilitate proper fit and positioning of the cushion assembly 18 relative to the damper rod 11, the upper rate washer 36 and the lower rate washer 26 may be provided with fingers 38 and 40, respectively, that engage the cushion assembly. The shape of the cushion assembly 18 and its physical properties may be altered as necessary to enhance performance of the mount assembly 10 in a manner known in the art. Through this structure, the damper piston rod 11 moves relative to the tower 12 by means of deflection of the elastomeric cushion 18. The upper rate washer 36 and lower rate washer 26 are collectively referred to as clamping members.

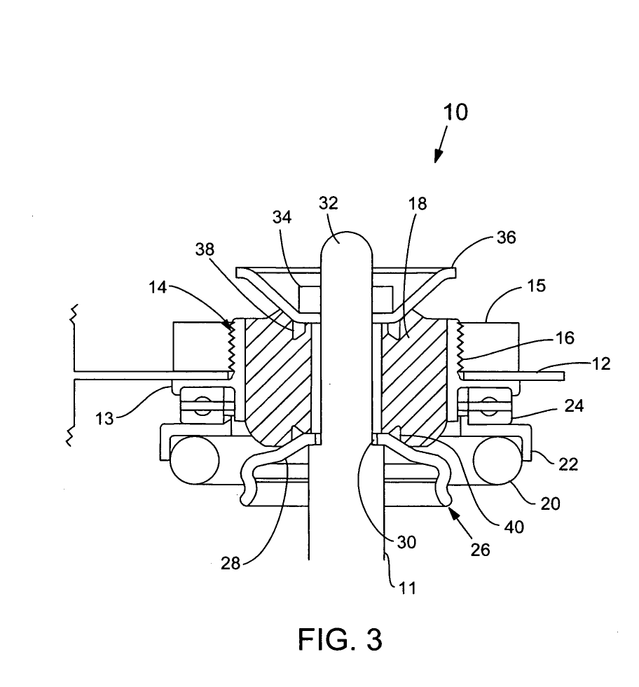

FIG. 3 shows the attachment mount of FIG. 1 with an expanded view of the body illustrated, further illustrating the inventive attachment herein.

Attachment is accomplished by means of a single point connection by virtue of the nut 15 being threaded onto external threads on the mount housing 14. No other fasteners are required to attach the mount assembly 10 to the tower 12. The nut 15 may also provide the optional feature of serving as a simple camber and caster adjustment mechanism in the associated suspension system.

Accordingly, an upper mount assembly is provided that is relatively easily attached to the tower, includes relatively few individual components, and exhibits tuning and packaging flexibility. Attachment to the tower is accomplished through a single point type connection system that advantageously expedites assembly of the associated suspension system. The upper mount is rigidly attached to the body by trapping the tower between two rigid components of the mount while the damper rod tenon is free to move relative to the clamping members of the mount and relative to the tower, while preferably no relative movement occurs between the clamping members of the mount and the tower. Additionally, damper loads are accepted in shear, while a separate path is provided for the vehicle loads.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A mount assembly for connecting a damper rod to a body, the mount assembly comprising:
a tower, the tower including an annular opening and a proximal attachment portion, wherein the tower is connected to the body at the proximal attachment portion,
a mount housing having a vertical portion extending through the annular opening and a flange disposed on one side of the tower;
a nut disposed on a side of the tower opposite the one side, the nut being engaged with the vertical portion of the mount housing;
a resilient cushion assembly disposed within the vertical portion of the mount housing, the damper rod extending through the resilient cushion assembly; and
a spring engaged with the tower and adapted to transfer loads to the tower.

2. The damper mount assembly of claim 1 further comprising a lower rate washer disposed between the damper rod and the resilient cushion assembly.

3. The damper mount assembly of claim 1 further comprising an upper rate washer engaged with the resilient cushion assembly on the opposite side of the tower.

4. The damper mount assembly of claim 3 further comprising a second nut engaged with the damper rod and engaged with the upper rate washer.

5. The damper mount assembly of claim 1 further comprising a spring seat disposed between the spring and the tower.

6. The damper mount assembly of claim 5 wherein the spring seat is disposed between the spring and the mount housing flange.

7. The damper mount assembly of claim 1 further comprising a bearing disposed between the spring and the tower.

8. The damper mount assembly of claim 7 wherein the bearing is disposed between the spring and the mount housing flange.

9. A mount assembly for connecting a damper rod to a body, the mount assembly comprising:
a tower, the tower including an annular opening and a proximal attachment portion, wherein the tower is connected to the body at the proximal attachment portion,
a mount housing having a vertical portion extending through the annular opening and a flange disposed on one side of the tower;
a nut disposed on a side of the tower opposite the one side, the nut being engaged with the vertical portion of the mount housing;
a resilient cushion assembly disposed within the vertical portion of the mount housing, the damper rod extending through the resilient cushion assembly;
a spring engaged with the tower and adapted to transfer loads to the tower; and
a lower rate washer disposed between the damper rod and the resilient cushion assembly.

10. The damper mount assembly of claim 9 further comprising an upper rate washer engaged with the resilient cushion assembly on the opposite side of the tower.

11. The damper mount assembly of claim 10 further comprising a second nut engaged with the damper rod and engaged with the upper rate washer.

12. The damper mount assembly of claim 9 further comprising a spring seat disposed between the spring and the tower.

13. The damper mount assembly of claim 12 wherein the spring seat is disposed between the spring and the mount housing flange.

14. The damper mount assembly of claim 9 further comprising a bearing disposed between the spring and the tower.

15. The damper mount assembly of claim 14 wherein the bearing is disposed between the spring and the mount housing flange.

16. A mount assembly for connecting a damper rod to a tower, the mount assembly comprising:
a tower, the tower including an annular opening and a proximal attachment portion, wherein the tower is connected to the body at the proximal attachment portion,
a mount housing having a vertical portion extending through the annular opening and a flange disposed on one side of the tower;
a nut disposed on a side of the tower opposite the one side, the nut being engaged with the vertical portion of the mount housing;
a resilient cushion assembly disposed within the vertical portion of the mount housing, the damper rod extending through the resilient cushion assembly;
a spring engaged with the tower and adapted to transfer loads to the tower;
a lower rate washer disposed between the damper rod and the resilient cushion assembly; and
an upper rate washer engaged with the resilient cushion assembly on the opposite side of the tower.

17. The damper mount assembly of claim 16 further comprising a second nut engaged with the damper rod and engaged with the upper rate washer.

18. The damper mount assembly of claim 16 further comprising a spring seat disposed between the spring and the mount housing flange.

19. The damper mount assembly of claim 16 further comprising a bearing disposed between the spring and the tower.

20. The damper mount assembly of claim 19 wherein the bearing is disposed between the spring and the mount housing flange.
